(19) United States
(12) Patent Application Publication
(10) Pub. No.: US 2025/0387758 A1
(43) Pub. Date: Dec. 25, 2025

(54) CO2-Photothermal Dual-Responsive Nanoemulsion Separation Membrane and Preparation Method Thereof and Applications Thereof

(71) Applicant: JIANGNAN UNIVERSITY, Yixing (CN)

(72) Inventors: Liangliang Dong, Yixing (CN); Yangyang Wang, Yixing (CN); Feifei Dong, Yixing (CN); Bo Zhu, Yixing (CN); Yunxiang Bai, Yixing (CN); Chunfang Zhang, Yixing (CN)

(73) Assignee: JIANGNAN UNIVERSITY, Yixing (CN)

(21) Appl. No.: 19/305,763

(22) Filed: Aug. 21, 2025

(30) Foreign Application Priority Data
May 22, 2023 (CN) 202310574933.0

(51) Int. Cl. B01D 69/02; B01D 67/00; B01D 69/12; B01D 71/02; B01D 71/38; B01D 71/40; B01D 71/48; C02F 1/40; C02F 1/44; C02F 101/32

(52) U.S. Cl. CPC B01D 69/02; B01D 67/00793; B01D 69/1216; B01D 71/0211; B01D 71/381; B01D 71/401; B01D 71/48; C02F 1/40; C02F 1/44; B01D 2325/39; C02F 2101/32

(57) ABSTRACT

The present invention provides a CO₂-photothermal dual-responsive nanoemulsion separation membrane, relating to the field of chemical separation technology. The membrane is woven from fibers with a three-layer structure: (i) a fiber core, (ii) a middle photothermal coating of carbon-based nanomaterials and polyvinyl alcohol, and (iii) an outer CO₂-responsive functional coating synthesized via free radical polymerization of a CO₂-responsive monomer and a hard monomer. The separation membrane has a pore size distribution below 0.1 μm. It exhibits excellent photothermal performance, enabling significant temperature increase on the membrane surface within 15 seconds under near-infrared irradiation, thereby achieving a transition from a protonated to a deprotonated state within 1 minute.

### CROSS-REFERENCE TO RELATED APPLICATIONS

This application claims priority to the Chinese Patent Application No. 202310574933.0, filed on May 22, 2023, entitled “A CO₂-PHOTOTHERMAL DUAL-RESPONSIVE NANOEMULSION SEPARATION MEMBRANE AND PREPARATION METHOD THEREOF AND APPLICATIONS THEREOF,” the entire contents of which are incorporated herein by reference.

### TECHNICAL FIELD

The present invention pertains to the field of chemical separation technology, specifically to oil-water separation membranes. More particularly, the invention relates to a CO₂-photothermal dual-responsive nanoemulsion separation membrane and methods for its preparation and use.

### BACKGROUND

Frequent oil spill accidents and the discharge of large volumes of industrial and domestic wastewater cause severe environmental pollution and health hazards, making the development of efficient oil-water separation membranes a current research hotspot. Stimuli-responsive separation membranes represent a class of intelligent membranes capable of spontaneously adjusting their physicochemical properties by sensing environmental changes, enabling reversible regulation of membrane flux and selectivity. This characteristic provides flexibility and controllability in practical oil-water separation processes.

Compared with traditional stimuli (e.g., pH, light, heat, redox), using CO₂ as a stimulus offers unique advantages for responsive membranes, including elimination of membrane fouling, avoidance of structural damage, absence of chemical accumulation, deep response penetration, and high cycling stability.

Consequently, CO₂-responsive separation membranes are now a key research focus. However, existing CO₂-responsive membranes can only separate immiscible oil-water mixtures and exhibit low efficiency for various stable emulsion systems. Additionally, their preparation processes are complicated, inefficient, and difficult to scale for large-area membranes.

Most critically, CO₂-responsive polymers typically undergo protonation under CO₂ exposure but require inert gases (e.g., N₂) for deprotonation. Because inert gases have low solubility in aqueous solutions, this deprotonation process is highly time-consuming, leading to slow deprotonation at the membrane surface. This results in response times to inert gases typically exceeding 20 minutes, which greatly limits industrial applications of such membranes.

### SUMMARY

The technical problem to be solved by the present invention is to provide a nanoemulsion separation membrane that enables rapid deprotonation and achieves rapid reversible switching between hydrophobic/oleophilic and hydrophilic/underwater oleophobic wettability states.

The first objective of the present invention is to provide a CO₂-photothermal dual-responsive nanoemulsion separation membrane, wherein the membrane is woven from fibers with a three-layer structure:
(i) a fiber core;
(ii) a middle photothermal conversion functional coating formed from carbon-based nanomaterials and polyvinyl alcohol; and
(iii) an outer CO₂-responsive functional coating synthesized via free radical polymerization of a CO₂-responsive monomer and a hard monomer, wherein the separation membrane has a pore size distribution below 0.1 μm.

The photothermal conversion layer is hydrophilic. If exposed directly to an aqueous environment, it tends to detach. Thus, the outer CO₂-responsive layer is essential to cover and protect this layer from detachment.

In certain embodiments, the fiber material comprising the group consisting of polyethylene terephthalate (PET), polyester fibers, polyacrylonitrile (PAN) fibers, polyamide (nylon) fibers, spandex fibers, carbon fibers, and glass fibers. The carbon-based nanomaterial comprises one or more of carbon black, carbon nanotubes, graphene, graphene oxide (GO), and reduced graphene oxide (rGO). The CO₂-responsive monomer comprising the group consisting of N,N-dimethyl-p-aminostyrene (DMSt), dimethylaminoethyl methacrylate (DMAEMA), and diethylaminoethyl methacrylate (DEAEMA). The hard monomer comprising the group consisting of styrene (ST), hydroxyethyl methacrylate (HEMA), acrylamide (AM), methyl methacrylate (MMA), poly (ethylene glycol) methyl ether methacrylate (PEGMA), and 2-ethoxyethyl methacrylate (EEMA).

In some embodiments: The carbon-based nanomaterial and polyvinyl alcohol (PVA) are present at a mass ratio of 3:1000 to 10:1000. Preferably, the carbon-based nanomaterial and PVA are at a mass ratio of 3:1000.

In some embodiments: The CO₂-responsive monomer and hard monomer are present at a molar ratio of 1:1 to 1:2. Preferably, the CO₂-responsive monomer and hard monomer are at a molar ratio of 1:1.

The second objective of the present invention is to provide a method for preparing the CO₂-photothermal dual-responsive nanoemulsion separation membrane, comprising the following steps:

### Step S1: Preparation of Photothermal Conversion Coating Material

Add 7.5-12.5 wt % polyvinyl alcohol (PVA) and deionized water to a flask. Then add 0.2-0.5 mg/mL carbon-based nanomaterial. Heat and stir the mixture at 90-110° C. in an oil bath for 30-90 minutes, yielding the photothermal conversion coating material.

### Step S2: Preparation of CO₂-Responsive Coating Material

Synthesize a CO₂-responsive polymer by free radical polymerization of a CO₂-responsive monomer and one hard monomer in tetrahydrofuran (THF). Dissolve the resulting CO₂-responsive polymer in ethanol to prepare a CO₂-responsive coating material with a 5-20 wt % mass fraction.

### Step S3: Preparation of CO₂-Photothermal Dual-Responsive Fibers

Uniformly coat the photothermal conversion coating material (from S1) onto PET fiber surfaces using a sizing machine. Thermally treat at 70-90° C. in an oven for 2-10 minutes to obtain photothermal functional fibers.

Then, uniformly coat the CO₂-responsive coating material (from S2) onto the surfaces of the photothermal functional fibers using a sizing machine. Thermally treat at 70-90° C. for 2-10 minutes to obtain CO₂-photothermal dual-responsive fibers.

### Step S4: Preparation of CO₂-Photothermal Dual-Responsive Nanoemulsion Separation Membrane

Weave the CO₂-photothermal dual-responsive fibers (from S3) into a membrane using a loom, yielding the final CO₂-photothermal dual-responsive nanoemulsion separation membrane.

In some embodiments, the CO₂-responsive coating material is transparent, exhibiting 85-92% light transmittance when formed into a film.

A third object of the present invention is to provide an application of the CO₂-photothermal dual-responsive nanoemulsion separation membrane. The membrane achieves reversible switching between superhydrophobic/superoleophilic and superhydrophilic/underwater superoleophobic states upon CO₂ or photothermal stimulation.

In one embodiment, CO₂ stimulation comprises: placing the membrane in an aqueous environment and bubbling CO₂ for 5 minutes. Photothermal stimulation comprises irradiating the membrane with a near-infrared (NIR) light source, wherein the membrane surface temperature increases to 120-180° C. within 10-20 seconds.

In one embodiment: Method for Separating Oil-Water Mixtures:

For water-in-oil (W/O) nanoemulsions: Use the membrane in its initial hydrophobic/oleophilic state;

For oil-in-water (O/W) nanoemulsions: Convert the hydrophobic/oleophilic membrane to a hydrophilic/underwater oleophobic state by placing it in water and bubbling CO₂ for 5 minutes; Perform separation using the converted membrane;

To re-separate W/O nanoemulsions: Reconvert the hydrophilic membrane to a hydrophobic/oleophilic state by irradiating it in water with an 808 nm NIR light source (1.2 V) for 1 minute; Perform separation.

In one embodiment, the membrane exhibits reversible wettability switching under alternating CO₂/NIR stimulation:
(a) initially, the membrane exhibits a water contact angle (WCA) >150° (superhydrophobic);
(b) after placing the membrane in water and bubbling CO₂ for 5 minutes, the WCA decreases to 0° (superhydrophilic); and
(c) subsequently, upon irradiation with a near-infrared light for 1 minute, the WCA recovers to >150° (superhydrophobic).

The separation membrane provided herein, upon CO₂ stimulation, transitions to a hydrophilic state that allows water permeation. As the membrane surface is occupied by water, oil droplets cannot contact or penetrate the membrane, thereby rejecting oil droplets. Conversely, after near-infrared (NIR) stimulation, photothermal energy enables rapid recovery of hydrophobicity, allowing oil permeation. With the surface occupied by oil, water droplets cannot contact or penetrate the membrane, thereby rejecting water droplets.

The membrane exhibits exceptional photothermal performance: its surface temperature increases significantly within 15 seconds under NIR irradiation, achieving a transition from protonated to deprotonated states within 1 minute. Compared to inert gas stimulation, the response time is reduced over 20-fold. In the superhydrophobic state, separation efficiency for 20-nm water-in-oil emulsions exceeds 99.5%. In the hydrophilic state, separation efficiency for 20-nm oil-in-water emulsions exceeds 99.5%.

The membrane has a narrowly distributed sub-micron pore size, enabling effective nanoemulsion separation.

The membrane supports large-scale fabrication, producing up to 4,800 cm2 membranes with consistent performance.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, where:

FIG. 1 schematically illustrates a membrane fabrication process, showing the transition from a blank membrane to a photothermal functional coating membrane, and finally to a CO₂-photothermal dual-responsive membrane according to some embodiments of the present disclosure;

FIG. 2 shows a cross-sectional SEM image of a fiber coated with both photothermal functional coating and CO₂-responsive functional coating, wherein the inner layer is photothermal functional coating, revealing sub-2 μm graphene oxide flakes and the outer layer is CO₂-responsive functional coating, exhibiting smoother and more uniform morphology than the inner layer according to some embodiments of the present disclosure.

FIG. 3 presents SEM images and optical photographs of (A) a blank membrane, (B) a photothermal functional coating membrane, and (C) a CO₂-photothermal dual-responsive membrane according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system”, “device”, “unit” and/or “module” used herein are a way to distinguish between different components, elements, parts, sections, or assemblies at different levels. However, the terms may be replaced by other expressions if other words accomplish the same purpose. In some examples, “photothermal functional fibers” may also be referred as “photothermal conversion functional fibers.” In some examples, “photothermal conversion coating” may be referred as “photothermal conversion functional coating.” In some examples, “photothermal conversion coating material” may be referred as “photothermal conversion functional coating material.”

As shown in the present disclosure and in the claims, unless the context clearly suggests an exception, the words “one”, “a”, “an”, “one kind”, and/or “the” do not refer specifically to the singular, but may also include the plural. Generally, the terms “including” and “comprising” suggest only the inclusion of clearly identified steps and elements, however, the steps and elements that do not constitute an exclusive list, and the method or apparatus may also include other steps or elements.

As shown in FIG. 1, some embodiments of the present disclosure disclose a preparation process of the CO₂-photothermal dual-responsive nanoemulsion separation membrane. The process may be illustrated by the following examples.

### Example 1: Preparation of CO₂-Photothermal Dual-Responsive Nanoemulsion Separation Membrane-1. The membrane may be Referred as “Membrane-1,” “CO₂-Photothermal Dual-Responsive Nanoemulsion Deparation Membrane-1” and the Like

The preparation of a CO₂-photothermal dual-responsive nanoemulsion separation membrane-1 may include using a carbon-based nanomaterial and forming a polymer. In this example, the carbon-based nanomaterial used may be graphene oxide, and the polymer may be formed by free radical polymerization of two monomers in solvent (e.g., a CO₂-responsive monomer DMAEMA and a hard monomer HEMA). The initiator dosage may be 1% of the total mass of DMAEMA and HEMA monomers.

The method for preparing the aforementioned CO₂-photothermal dual-responsive nanoemulsion separation membrane-1 may include the following steps:
S1: preparation of photothermal conversion coating material. S1 may include adding 7.5 wt % polyvinyl alcohol (PVA) and deionized water to a flask, then adding 0.2 mg/ml graphene oxide, and heating and stirring in oil bath at 90° C. for 30 minutes to obtain a photothermal conversion coating material. The photothermal conversion coating material may form a coating, and the coating may be referred as “photothermal conversion functional coating” or “photothermal conversion coating.” The photothermal conversion coating material may also be referred as “photothermal conversion functional coating material.” The photothermal conversion coating material may be referred as “S1 material.”
S2: preparation of CO₂-responsive coating material. S2 may include dissolving DMAEMA and HEMA (1:0.5 mass ratio) in tetrahydrofuran (THF), adding azobisisobutyronitrile (AIBN) initiator, reacting under N₂ atmosphere at 65° C. for 24 hours, precipitating a precipitated polymer in excess n-hexane, collecting and drying the precipitated polymer to obtain a CO₂-responsive polymer, dissolving the CO₂-responsive polymer in solvent to prepare a 5 wt % coating solution. A film formed from the 5 wt % coating solution exhibits a light transmittance of 92%. The 5 wt % coating solution may be referred as “S2 material.”
S3: preparation of CO₂-photothermal dual-responsive fibers. S3 may include uniformly coating the S1 material onto surfaces of PET fibers using a sizing machine to form coated fibers, thermally treating the coated fibers at 70° C. for 2 minutes to obtain photothermal functional fibers, uniformly coating the S2 material onto surfaces of the photothermal functional fibers using a sizing machine. The photothermal functional fibers that are uniformly coated with the S2 material may be referred as “intermediate fibers.” S3 may further include thermally treating the intermediate fibers at 70° C. for 2 minutes to obtain dual-responsive fibers. The photothermal functional fibers may also be referred as “photothermal conversion functional fibers.” The dual-responsive fibers may be referred as “CO₂-photothermal dual-responsive fibers,” “S3 fibers,” and the like.
S4: preparation of membrane-1. The membrane may be referred as “membrane-1,” “CO₂-photothermal dual-responsive nanoemulsion separation membrane-1,” and the like. S4 may include weaving the dual-responsive fibers obtained in S3 using a loom to obtain CO₂-photothermal dual-responsive nanoemulsion separation membrane-1. The CO₂-photothermal dual-responsive fibers prepared by S3 may be woven with a sum of warp and weft densities of 300T into the CO₂-photothermal dual-responsive nanoemulsion separation membrane-1 using the loom.

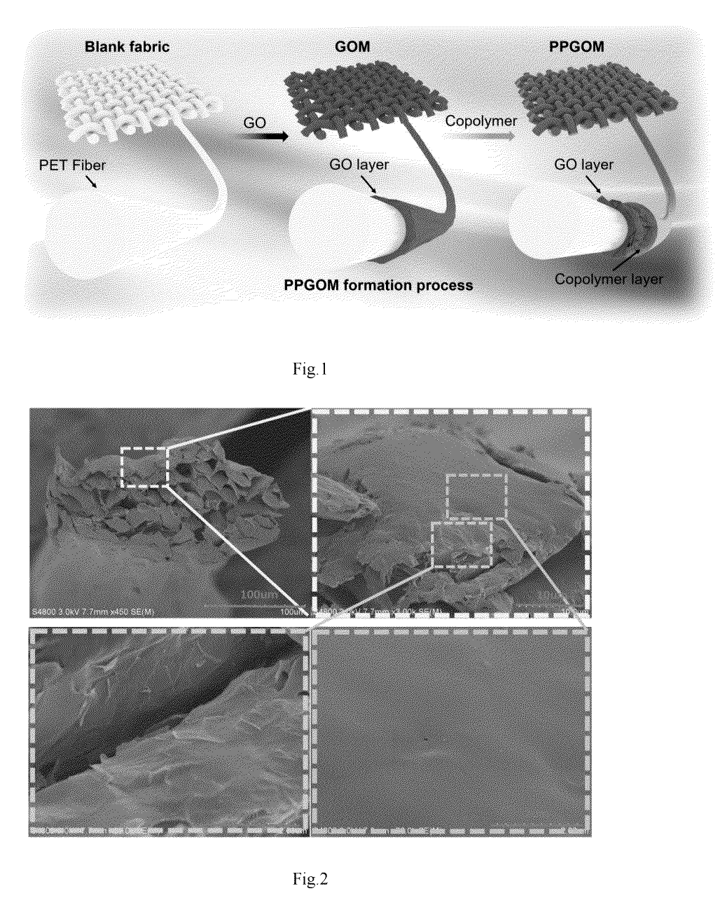

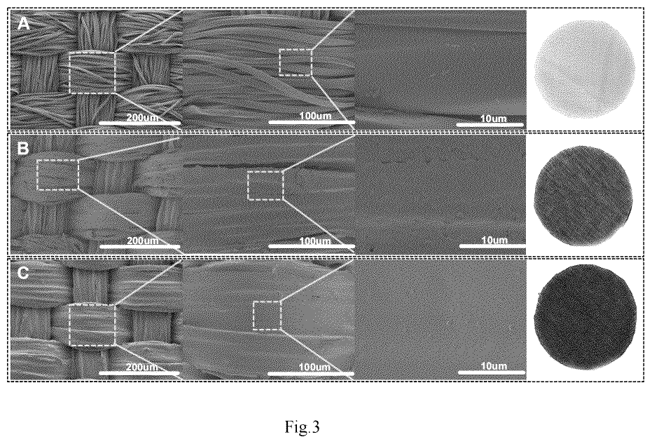

FIG. 1 depicts a membrane structure prepared with a core of PET fiber, a middle layer of graphene oxide coating, and an outer copolymer coating. FIG. 2 shows a fiber cross-sectional SEM image coated with photothermal functional and CO₂-responsive coatings, wherein the inner layer reveals <2 μm graphene oxide flakes and the outer layer is smoother/more uniform than the inner layer; FIG. 3C displays an SEM image of the prepared membrane exhibiting darker coloration and smoother surface texture relative to FIG. 3B's membrane lacking CO₂-responsive coating.

### Example 2: Wettability Switching Process of Membrane-1

A CO₂-photothermal dual-responsive nanoemulsion separation membrane-1 may be hydrophobic or oleophilic. The wettability of a CO₂-photothermal dual-responsive nanoemulsion separation membrane-1 may be switched as needed. The wettability switching process of membrane-1 may include placing a hydrophobic/oleophilic CO₂-photothermal dual-responsive nanoemulsion separation membrane-1 in water and bubbling CO₂ for 5 minutes to convert the hydrophobic/oleophilic CO₂-photothermal dual-responsive nanoemulsion separation membrane-1 to a hydrophilic/underwater superoleophobic membrane. The process may further include measuring a water contact angle (WCA) of the hydrophilic/underwater superoleophobic membrane in air via a contact angle goniometer, wherein the WCA is measured as 0°.

The wettability switching process may include irradiating the hydrophilic/underwater superoleophobic membrane with 1.2V, 808-nm near-infrared light for 1 minute to revert the hydrophilic/underwater superoleophobic membrane to a reverted membrane in hydrophobic/oleophilic state. The process may include measuring the WCA in air via contact angle goniometer of the reverted membrane, wherein the WCA is measured as 151.2°.

### Example 3: Performance Testing of Membrane-1

For water-in-oil nanoemulsion separation, the performance testing may include using a hydrophobic/oleophilic CO₂-photothermal dual-responsive nanoemulsion separation membrane-1 directly. Separation performance data are shown in Table 1.

For oil-in-water nanoemulsion separation, the performance testing may include placing the hydrophobic/oleophilic CO₂-photothermal dual-responsive nanoemulsion separation membrane-1 in water, bubbling CO₂ for 5 minutes to obtain a hydrophilic/underwater oleophobic membrane, and proceeding with separation. Relevant performance data are shown in Table 1.

For re-separating water-in-oil nanoemulsions, the performance testing may include irradiating a hydrophilic/underwater oleophobic membrane with a 1.2V, 808-nm near-infrared light for 1 minute to reconvert the hydrophilic/underwater oleophobic membrane to hydrophobic/oleophilic state before separation.

As shown in Table 1, the CO₂-photothermal dual-responsive nanoemulsion separation membrane-1 shows cyclic stability. The cyclic stability may be characterized by Separation Efficiency for Oil-in-Water Emulsion (%). As shown in Table 1, after 50 cycles of separation, the CO₂-photothermal dual-responsive nanoemulsion separation membrane-1 maintains greater than 99% efficiency for both isooctane water-in-oil nanoemulsions (20 nm) and oil-in-water nanoemulsions (20 nm).

### Example 4: Preparation of CO₂-Photothermal Dual-Responsive Nanoemulsion Separation Membrane-2. The Membrane may be Referred as “Membrane-2,” “CO₂-Photothermal Dual-Responsive Nanoemulsion Separation Membrane-2,” and the Like

The preparation of a CO₂-photothermal dual-responsive nanoemulsion separation Membrane-2 may include using a carbon-based nanomaterial and forming a polymer. In this example, the carbon-based nanomaterial used may be graphene, and the polymer may be formed by free radical polymerization of two monomers in solvent (e.g., a CO₂-responsive monomer DMSt and a hard monomer HEMA). The initiator dosage may be 1% of the total mass of DMSt and HEMA monomers.

The method for preparing the aforementioned CO₂-photothermal dual-responsive nanoemulsion separation membrane-2 may include the following steps:
S1: preparation of photothermal conversion coating material. S1 may include adding 10 wt % polyvinyl alcohol (PVA) and deionized water to a flask, then adding 0.3 mg/ml graphene, heating and stirring in oil bath at 100° C. for 1 hour to obtain photothermal conversion coating material. The photothermal conversion coating material may be referred as “S1 material.”
S2: preparation of CO₂-responsive coating material. S2 may include dissolving DMSt and HEMA (1:0.5 mass ratio) in tetrahydrofuran (THF), adding azobisisovaleronitrile initiator, reacting under N₂ or Nitrogen atmosphere at 75° C. for 36 hours, precipitating a precipitated polymer in excess n-hexane, collecting and drying the precipitated polymer to obtain a CO₂-responsive polymer, and dissolving the CO₂-responsive polymer in solvent to prepare a 10 wt % coating solution. A film formed from the 10 wt % coating solution exhibits a light transmittance of 90%. The 10 wt % coating solution may be referred as “S2 material.”
S3: preparation of CO₂-photothermal dual-responsive fibers. S3 may include uniformly coating S1 material onto acrylic fibers (PAN) using a sizing machine, thermally treating the S1 coated PAN at 80° C. for 5 minutes to obtain photothermal functional fibers. The S1 coated PAN may be referred as “intermediate fibers.” S3 may further include uniformly coating S2 material onto the intermediate fibers using a sizing machine and thermally treating the intermediate fibers uniformly coated with S2 material at 80° C. for 5 minutes to obtain dual-responsive fibers. The dual-responsive fibers may be referred as “S3 fibers.”
S4: preparation of membrane-2. S4 may include weaving the dual-responsive fibers obtained in S3 using a loom to obtain CO₂-photothermal dual-responsive nanoemulsion separation membrane-2. The CO₂-photothermal dual-responsive fibers prepared by S3 may be woven with a sum of warp and weft densities of 330T into the CO₂-photothermal dual-responsive nanoemulsion separation membrane-2 using the loom.

### Example 5: Wettability Switching Process of Membrane-2

A CO₂-photothermal dual-responsive nanoemulsion separation membrane-2 may be hydrophobic or oleophilic. The wettability of a CO₂-photothermal dual-responsive nanoemulsion separation membrane-2 may be switched as needed. The wettability switching process of membrane-2 may include placing a hydrophobic/oleophilic CO₂-photothermal dual-responsive nanoemulsion separation membrane-2 in water, bubbling CO₂ for 8 minutes to convert to a hydrophilic/underwater superoleophobic membrane. The process may further include measuring a water contact angle (WCA) of the hydrophilic/underwater superoleophobic membrane in air via a contact angle goniometer, wherein the WCA is measured as 0°.

The wettability switching process may include irradiating the hydrophilic/underwater superoleophobic membrane with 1.5V, 780-nm near-infrared light for 1.5 minute to revert the hydrophilic/underwater superoleophobic membrane to a reverted membrane in hydrophobic/oleophilic state. The process may include measuring the WCA in air via contact angle goniometer of the reverted membrane, wherein the WCA is measured as 150.6°.

### Example 6: Performance Testing of Membrane-2

For water-in-oil nanoemulsion separation, the performance testing may include using a hydrophobic/oleophilic CO₂-photothermal dual-responsive nanoemulsion separation membrane-2 directly. Separation performance data are shown in Table 1.

For oil-in-water nanoemulsion separation, the performance testing may include placing the hydrophobic/oleophilic CO₂-photothermal dual-responsive nanoemulsion separation membrane-2 in water, bubbling CO₂ for 8 minutes to obtain a hydrophilic/underwater oleophobic membrane, and proceeding with separation. Relevant performance data are shown in Table 1.

For re-separating water-in-oil nanoemulsions, the performance testing may include irradiating a hydrophilic/underwater oleophobic membrane with a 1.5V, 780-nm near-infrared light for 1.5 minute to reconvert the hydrophilic/underwater oleophobic membrane to hydrophobic/oleophilic state before separation and proceeding with separation. Relevant performance data are shown in Table 1.

As shown in Table 1, the CO₂-photothermal dual-responsive nanoemulsion separation membrane-2 shows cyclic stability. The cyclic stability may be characterized by Separation Efficiency for Oil-in-Water Emulsion (%). As shown in Table 1, after 50 cycles of separation, the CO₂-photothermal dual-responsive nanoemulsion separation membrane-2 maintains greater than 99% efficiency for both isooctane water-in-oil nanoemulsions (20 nm) and oil-in-water nanoemulsions (20 nm).

### Example 7: Preparation of CO₂-Photothermal Dual-Responsive Nanoemulsion Separation Membrane-3. The Membrane May be Referred as “Membrane-3,” “CO₂-Photothermal Dual-Responsive Nanoemulsion Separation Membrane-3,” and the Like

The preparation of a CO₂-photothermal dual-responsive nanoemulsion separation Membrane-3 may include using a carbon-based nanomaterial and forming a polymer. In this example, the carbon-based nanomaterial used may be carbon nanotubes and the polymer may be formed by free radical polymerization of two monomers in solvent (e.g., a CO₂-responsive monomer DMSt and a hard monomer AEMA). The initiator dosage may be 1% of the total mass of DMSt and AEMA monomers.

The method for preparing the aforementioned CO₂-photothermal dual-responsive nanoemulsion separation membrane-3 may include the following steps:
S1: preparation of photothermal conversion coating material. S1 may include adding 12.5 wt % polyvinyl alcohol (PVA) and deionized water to a flask, then adding 0.4 mg/ml carbon nanotubes, heating and stirring in oil bath at 95° C. for 90 minutes to obtain photothermal conversion coating material. The photothermal conversion coating material may be referred as “S1 material.”
S2: preparation CO₂-responsive coating material. S2 may include dissolving DMSt and AEMA (1:1.5 mass ratio) in tetrahydrofuran (THF), adding benzoyl peroxide initiator, reacting under N₂ or Nitrogen atmosphere at 85° C. for 36 hours, precipitating a precipitated polymer in excess n-hexane, collect and dry the precipitated polymer to obtain a CO₂-responsive polymer, and dissolving the CO₂-responsive polymer in solvent to prepare a 20 wt % coating solution. A film formed from the 20 wt % coating solution exhibits a light transmittance of 85%. The 20 wt % coating solution may be referred as “S2 material.”
S3: preparation of CO₂-photothermal dual-responsive fibers. S3 includes uniformly coating S1 material onto polyamide fibers (i.e., nylon) using a sizing machine, thermally treating at 90° C. for 10 minutes to obtain photothermal functional fibers, and uniformly coating S2 material onto the photothermal functional fibers using a sizing machine. The photothermal functional fibers that are uniformly coated with the S2 material may be referred as “intermediate fibers.” S3 may further include thermally treating the intermediate fibers at 90° C. for 10 minutes to obtain dual-responsive fibers. The dual-responsive fibers may be referred as “CO₂-photothermal dual-responsive fibers,” “S3 fibers,” and the like.
S4: preparation of membrane-3. S4 may include weaving the dual-responsive fibers obtained in S3 using a loom to obtain CO₂-photothermal dual-responsive nanoemulsion separation membrane-3. The CO₂-photothermal dual-responsive fibers prepared by S3 may be woven with a sum of warp and weft densities of 350T into the CO₂-photothermal dual-responsive nanoemulsion separation membrane-3 using the loom.

### Example 8: Wettability Switching Process of Membrane-3

A CO₂-photothermal dual-responsive nanoemulsion separation membrane-3 may be hydrophobic or oleophilic. The wettability of a CO₂-photothermal dual-responsive nanoemulsion separation membrane-3 may be switched as needed. The wettability switching process of membrane-3 may include placing a hydrophobic/oleophilic CO₂-photothermal dual-responsive nanoemulsion separation membrane-3 in water, bubbling CO₂ for 10 minutes to convert to a hydrophilic/underwater superoleophobic membrane. The process may further include measuring a water contact angle (WCA) of the hydrophilic/underwater superoleophobic membrane in air via a contact angle goniometer, wherein the WCA is measured as 0°.

The wettability switching process may include irradiating the hydrophilic/underwater superoleophobic membrane with 2V, 900-nm near-infrared light for 2 minutes to revert the hydrophilic/underwater superoleophobic membrane to a reverted membrane in hydrophobic/oleophilic state. The process may include measuring the WCA in air via contact angle goniometer of the reverted membrane, wherein the WCA is measured as 152.3°.

### Example 9: Performance Testing of Membrane-3

For water-in-oil nanoemulsion separation, the performance testing may include using a hydrophobic/oleophilic CO₂-photothermal dual-responsive nanoemulsion separation membrane-3 directly. Separation performance data are shown in Table 1.

For oil-in-water nanoemulsion separation, the performance testing may include placing the hydrophobic/oleophilic CO₂-photothermal dual-responsive nanoemulsion separation membrane-3 in water, bubbling CO₂ for 10 minutes to obtain a hydrophilic/underwater oleophobic membrane, and proceeding with separation. Relevant performance data are shown in Table 1.

For re-separating water-in-oil nanoemulsions, the performance testing may include irradiating a hydrophilic/underwater oleophobic membrane with a 2V, 900-nm near-infrared light for 2 minutes to reconvert the hydrophilic/underwater oleophobic membrane to hydrophobic/oleophilic state before separation and proceeding with separation. Relevant performance data are shown in Table 1.

As shown in Table 1, the CO₂-photothermal dual-responsive nanoemulsion separation membrane-3 shows cyclic stability. The cyclic stability may be characterized by Separation Efficiency for Oil-in-Water Emulsion (%). As shown in Table 1, after 50 cycles of separation, the CO₂-photothermal dual-responsive nanoemulsion separation membrane-3 maintains greater than 99% efficiency for both isooctane water-in-oil nanoemulsions (20 nm) and oil-in-water nanoemulsions (20 nm).

### Example 10: Preparation of CO₂-Photothermal Dual-Responsive Nanoemulsion Separation Membrane-4. The Membrane may be Referred as “Membrane-4,” “CO₂-Photothermal Dual-Responsive Nanoemulsion Separation Membrane-4” and the Like

The preparation of a CO₂-photothermal dual-responsive nanoemulsion separation Membrane-4 may include using a carbon-based nanomaterial and forming a polymer. In this example, the carbon-based nanomaterial used may be reduced graphene oxide (rGO) and the polymer may be formed by free radical polymerization of two monomers in solvent (e.g., a CO₂-responsive monomer DMAEMA and a hard monomer AEMA). The initiator dosage may be 1% of the total mass of DMAEMA and AEMA monomers.

The method for preparing the aforementioned CO₂-photothermal dual-responsive nanoemulsion separation membrane-4 may include the following steps:
S1: preparation of photothermal conversion coating material. S1 may include adding 10 wt % polyvinyl alcohol (PVA) and deionized water to a flask, then adding 0.4 mg/ml rGO, heating and stirring in oil bath at 95° C. for 1 hour to obtain photothermal conversion coating material. The photothermal conversion coating material may be referred as “S1 material.”
S2: preparation CO₂-responsive coating material. S2 may include dissolving DMAEMA and AEMA (1:2 mass ratio) in tetrahydrofuran (THF), adding benzoyl peroxide initiator, reacting under N₂ or Nitrogen atmosphere at 85° C. for 48 hours, precipitating a precipitated polymer in excess n-hexane, collect and dry the precipitated polymer to obtain a CO₂-responsive polymer, and dissolving the CO₂-responsive polymer in solvent to prepare a 10 wt % coating solution. A film formed from the 10 wt % coating solution exhibits a light transmittance of 88%. The 10 wt % coating solution may be referred as “S2 material.”
S3: preparation of CO₂-photothermal dual-responsive fibers. S3 includes uniformly coating S1 material onto polyester fibers using a sizing machine, thermally treating at 75° C. for 4 minutes to obtain photothermal functional fibers, and uniformly coating S2 material onto the photothermal functional fibers using a sizing machine. The photothermal functional fibers that are uniformly coated with the S2 material may be referred as “intermediate fibers.” S3 may further include thermally treating the intermediate fibers at 75° C. for 4 minutes to obtain dual-responsive fibers. The dual-responsive fibers may be referred as “CO₂-photothermal dual-responsive fibers,” “S3 fibers,” and the like.
S4: preparation of membrane-4. S4 may include weaving the dual-responsive fibers obtained in S3 using a loom to obtain CO₂-photothermal dual-responsive nanoemulsion separation membrane-4. The CO₂-photothermal dual-responsive fibers prepared by S3 may be woven with a sum of warp and weft densities of 300T into the CO₂-photothermal dual-responsive nanoemulsion separation membrane-4 using the loom.

### Example 11: Wettability Switching Process of Membrane-4

A CO₂-photothermal dual-responsive nanoemulsion separation membrane-4 may be hydrophobic or oleophilic. The wettability of a CO₂-photothermal dual-responsive nanoemulsion separation membrane-4 may be switched as needed. The wettability switching process of membrane-4 may include placing a hydrophobic/oleophilic CO₂-photothermal dual-responsive nanoemulsion separation membrane-4 in water, bubbling CO₂ for 5 minutes to convert to a hydrophilic/underwater superoleophobic membrane. The process may further include measuring a water contact angle (WCA) of the hydrophilic/underwater superoleophobic membrane in air via a contact angle goniometer, wherein the WCA is measured as 0°.

The wettability switching process may include irradiating the hydrophilic/underwater superoleophobic membrane with 1.2V, 808-nm near-infrared light for 1 minute to revert the hydrophilic/underwater superoleophobic membrane to a reverted membrane in hydrophobic/oleophilic state. The process may include measuring the WCA in air via contact angle goniometer of the reverted membrane, wherein the WCA is measured as 151.0°.

### Example 12: Performance Testing of Membrane-4

For water-in-oil nanoemulsion separation, the performance testing may include using a hydrophobic/oleophilic CO₂-photothermal dual-responsive nanoemulsion separation membrane-4 directly. Separation performance data are shown in Table 1.

For oil-in-water nanoemulsion separation, the performance testing may include placing the hydrophobic/oleophilic CO₂-photothermal dual-responsive nanoemulsion separation membrane-4 in water, bubbling CO₂ for 5 minutes to obtain a hydrophilic/underwater oleophobic membrane, and proceeding with separation. Relevant performance data are shown in Table 1.

For re-separating water-in-oil nanoemulsions, the performance testing may include irradiating a hydrophilic/underwater oleophobic membrane with a 1.2V, 808-nm near-infrared light for 1 minute to reconvert the hydrophilic/underwater oleophobic membrane to hydrophobic/oleophilic state before separation and proceeding with separation. Relevant performance data are shown in Table 1.

As shown in Table 1, the CO₂-photothermal dual-responsive nanoemulsion separation membrane-4 shows cyclic stability. The cyclic stability may be characterized by Separation Efficiency for Oil-in-Water Emulsion (%). As shown in Table 1, after 50 cycles of separation, the CO₂-photothermal dual-responsive nanoemulsion separation membrane-4 maintains greater than 99% efficiency for both isooctane water-in-oil nanoemulsions (20 nm) and oil-in-water nanoemulsions (20 nm).

### Comparative Example 1: Effect of Absence of Carbon-Based Nanomaterial on Deprotonation

In this example, the polymer may be formed by free radical polymerization of two monomers in solvent (e.g., a CO₂-responsive monomer DMAEMA and a hard monomer HEMA). The initiator dosage may be 1% of total monomer mass.

The method for preparing the CO₂-responsive nanoemulsion separation membrane may include the following steps:
S1: preparation of PVA coating material. S1 may include adding 7.5 wt % polyvinyl alcohol (PVA) and deionized water to a flask, heating and stirring in oil bath at 95° C. for 30 minutes to obtain PVA coating material. The PVA coating material may be referred as “S1 material.”
S2: Preparation of CO₂-responsive coating material. S2 may include dissolving DMAEMA and HEMA (1:0.5 mass ratio) in tetrahydrofuran (THF), adding azobisisobutyronitrile (AIBN) initiator, reacting under N₂ or Nitrogen atmosphere at 65° C. for 24 hours, precipitating polymer in excess n-hexane, collecting and drying the precipitated polymer, and dissolving the precipitated polymer in solvent to obtain 5 wt % CO₂-responsive coating material. The 5 wt % CO₂-responsive coating material may be referred as “S2 material.”
S3: preparation of CO₂-responsive fibers. S3 may include uniformly coating S1 material onto PET fibers using a sizing machine, thermally treating the coated PET fibers at 80° C. for 5 minutes to obtain PVA-coated fibers, uniformly coating S2 material onto the PVA-coated fibers, and thermally treating the PVA-coated fibers uniformly coated with S2 material at 80° C. for 4 minutes to obtain CO₂-responsive fibers. The CO₂-responsive fibers may be referred as “S3 fibers.”
S4: preparation of membrane. S4 may include weaving S3 fibers using a loom to obtain CO₂-responsive nanoemulsion separation membrane. The S3 fibers may be woven with a sum of warp and weft densities of 300T into the CO₂-responsive nanoemulsion separation membrane using the loom.

For isooctane oil-in-water nanoemulsions (20 nm), when separating oil-water mixtures using the CO₂-responsive nanoemulsion separation membrane, the process may include placing a hydrophobic/oleophilic separation membrane in an aqueous environment and bubbling CO₂ for 5 minutes to convert the hydrophobic/oleophilic separation membrane to a hydrophilic/underwater oleophobic separation membrane before separation. Separation performance test data are shown in Table 1 as Comparative Example 1. For isooctane water-in-oil nanoemulsions (20 nm), the process may include irradiating a hydrophilic/underwater oleophobic separation membrane with a 1.2V, 808-nm NIR light source for 1 minute before separation. Relevant performance data are shown in Table 1 as Comparative Example 1.

Comparison between Comparative Example 1 and membrane-1 reveals that the absence of carbon-based nanomaterials causes the membrane to lose photothermal deprotonation capability, leading to significant reduction in separation flux and performance for water-in-oil emulsions. Photothermal energy from carbon-based nanomaterials directly supplies energy for deprotonating CO₂-responsive polymers, enabling rapid deprotonation and hydrophobicity recovery. Thus, membranes without carbon-based nanomaterials exhibit slower hydrophobicity recovery and degraded separation performance.

### Comparative Example 2: Effect of N₂ Deprotonation on Process Rate

In this example, the polymer is formed by free radical polymerization of two monomers in solvent (e.g., a CO₂-responsive monomer DMAEMA and a hard monomer HEMA). The initiator dosage may be 1% of total monomer mass.

The method for preparing a CO₂-responsive nanoemulsion separation membrane may include the following steps:
S1: preparation of PVA coating material. S1 may include adding 10 wt % polyvinyl alcohol (PVA) and deionized water to a flask, heating and stirring in oil bath at 95° C. for 1 hour to obtain PVA coating material. The PVA coating material may be referred as “S1 material.”
S2: preparation of CO₂-responsive coating material. S2 may include dissolving DMAEMA and HEMA (1:0.5 mass ratio) in tetrahydrofuran (THF), adding azobisisobutyronitrile (AIBN) initiator, reacting under N₂ and Nitrogen atmosphere at 65° C. for 24 hours, precipitating polymer in excess n-hexane, collecting and drying the precipitated polymer, and dissolving the precipitated polymer in solvent to 5 wt % CO₂-responsive coating material. The 5 wt % CO₂-responsive coating material may be referred as “S2 material.”
S3: preparation of CO₂-responsive fibers. S3 includes uniformly coating S1 material onto PET fibers using a sizing machine, thermally treating at 70° C. for 2 minutes to obtain PVA-coated fibers, uniformly coating S2 material onto PVA-coated fibers, thermally treating the PVA-coated fibers uniformly coated with S2 material at 70° C. for 2 minutes to obtain CO₂-responsive fibers. The CO₂-responsive fibers may be referred as “S3 fibers.”
S4: preparation of membrane. S4 may include weaving S3 fibers using a loom to obtain CO₂-responsive nanoemulsion separation membrane. The S3 fibers may be woven with a sum of warp and weft densities of 300T into the CO₂-responsive nanoemulsion separation membrane using the loom.

For isooctane oil-in-water nanoemulsions (20 nm), when separating oil-water mixtures using the CO₂-responsive nanoemulsion separation membrane, the process may include placing a hydrophobic/oleophilic separation membrane in an aqueous environment and bubbling CO₂ for 5 minutes to convert the hydrophobic/oleophilic separation membrane to a hydrophilic/underwater oleophobic separation membrane before separation. Separation performance test data are shown in Table 1 as Comparative Example 1. For isooctane water-in-oil nanoemulsions (20 nm), the process may include placing the hydrophilic/underwater oleophobic separation membrane in an aqueous environment and bubbling N₂ for 1 minute before separation. The results are shown in Table 1. A measured water contact angle is 46.3°.

Comparison with Comparative Example 2 reveals that N₂- induced deprotonation fails to restore contact angle >150° within 1 minute, indicating incomplete deprotonation, whereas photothermal deprotonation achieves >150° contact angle restoration in 1 minute, demonstrating superior speed and efficiency.

### Comparative Example 3: Effect of Reversed Coating Sequence on Separation efficiency.

In this example, the carbon-based nanomaterial used may be graphene oxide and the polymer may be formed by free radical polymerization of two monomers in solvent (e.g., a CO₂-responsive monomer DMSt and a hard monomer AEMA). Initiator dosage may be 1% of total monomer mass.

The method for preparing a nanoemulsion separation membrane may include the following steps:
S1: preparation of photothermal coating material. S1 may include adding 12.5 wt % PVA and deionized water to a flask, adding 0.5 mg/ml graphene oxide, heating and stirring at 95° C. in oil bath for 90 minutes to obtain photothermal coating material. The photothermal coating material may be referred as “S1 material.”
S2: prepare CO₂-responsive coating material. S2 may include dissolving DMSt and AEMA (1:1.5 mass ratio) in THE, adding benzoyl peroxide initiator, reacting under N₂ or Nitrogen atmosphere at 85° C. for 36 hours, precipitating polymer in excess n-hexane, collecting and drying the precipitated polymer, dissolving the precipitated polymer in solvent to prepare 20 wt % CO₂-responsive coating solution. The 20 wt % CO₂-responsive coating solution may be referred as “S2 material.”
S3: preparation of dual-responsive fibers. S3 may include uniformly coating S2 material onto PET fibers using a sizing machine, thermally treating the S2 material-coated PET fibers at 90° C. for 5 minutes to obtain CO₂-responsive fibers, uniformly coating S1 material onto the S2 material-coated PET fibers to obtain intermediate fibers, thermally treating the intermediate fibers at 90° C. for 5 minutes to obtain photothermal/CO₂ dual-responsive fibers. The photothermal/CO₂ dual-responsive fibers may be referred as “S3 material.”
S4: preparation of membrane. S4 may include weaving S3 fibers using a loom to obtain photothermal/CO₂ dual-responsive nanoemulsion separation membrane. The S3 fibers may be woven with a sum of warp and weft densities of 350T into the photothermal/CO₂ dual-responsive nanoemulsion separation membrane using the loom.

Wettability switching of Comparative Example 3. When needed, placing a hydrophobic/oleophilic photothermal/CO₂ dual-responsive nanoemulsion separation membrane in water and bubbling CO₂ for 5 minutes to obtain a hydrophilic/underwater oleophobic photothermal/CO₂ dual-responsive nanoemulsion separation membrane. When needed, irradiating the hydrophilic/underwater oleophobic photothermal/CO₂ dual-responsive nanoemulsion separation membrane with 1.2V, 808-nm NIR light for 1 minute to again obtain the hydrophobic/oleophilic photothermal/CO₂ dual-responsive nanoemulsion separation membrane.

Oil-water mixtures may be separated using a photothermal/CO₂ dual-responsive nanoemulsion separation membrane.

For water-in-oil nanoemulsions, the membrane may be used in its hydrophobic/oleophilic state directly. The separation performance data are shown in Table 1 as Comparative Example 3.

For oil-in-water nanoemulsions, a hydrophobic/oleophilic membrane may be placed in water, CO₂ may be bubbled for 5 minutes to convert the hydrophobic/oleophilic membrane to hydrophilic/underwater oleophobic state, and then separation is performed. The performance data are shown in Table 1 as Comparative Example 3.

For re-separating water-in-oil nanoemulsions, a hydrophilic membrane may be irradiated with 1.2V, 808-nm NIR light for 1 minute to reconvert the hydrophilic membrane to hydrophobic/oleophilic state, and then separation is performed.

Cyclic stability of Comparative Example 3. After 2 separation cycles, efficiency of Comparative Example 3 drops below 90% for both isooctane-based oil-in-water nanoemulsions (20 nm) and water-in-oil nanoemulsions (20 nm).

Comparison with Comparative Example 3 reveals that switching the coating sequence from photothermal-first to CO₂-responsive-first significantly reduces cyclic performance. The reduced cyclic performance occurs because the hydrophilic PVA material in the photothermal layer causes coating dissolution and detachment when externally exposed to aqueous environments, thereby enlarging membrane pores and severely degrading separation performance.

### Comparative Example 4: Effect of Absence of CO₂-Responsive Coating on Separation Efficiency

In this example, the carbon-based nanomaterial used may be graphene oxide. The method for preparing the photothermal-responsive nanoemulsion separation membrane may include the following specific steps:
S1: preparation of photothermal coating material. S1 may include adding 10 wt % PVA and deionized water to a flask, adding 0.3 mg/ml graphene oxide, and heating and stirring at 95° C. in oil bath for 1 hour to obtain photothermal coating material. The photothermal coating material may be referred as “S1 material.”
S2: preparation of photothermal fibers. S2 may include uniformly coating S1 material onto PET fibers using a sizing machine, thermally treating the coated PET fibers at 70° C. for 5 minutes to obtain photothermal responsive fibers. The photothermal responsive fibers may be referred as “S2 material.”
S4: preparation of membrane. S4 may include weaving S2 fibers using a loom to obtain photothermal-responsive nanoemulsion separation membrane. The S2 fibers may be woven with a sum of warp and weft densities of 350T into the photothermal-responsive nanoemulsion separation membrane using the loom.

Wettability switching of Comparative Example 4. When needed, placing a hydrophobic/oleophilic photothermal-responsive nanoemulsion separation membrane in an aqueous environment and bubble CO₂ for 5 minutes. When needed, irradiating the hydrophilic/underwater oleophobic photothermal-responsive nanoemulsion separation membrane with a 1.2V, 808-nm near-infrared light for 1 minute.

After placing the photothermal-responsive nanoemulsion separation membrane in water and bubbling CO₂ for 5 minutes, water contact angle (WCA) of the photothermal-responsive nanoemulsion separation membrane is measured in air using a contact angle goniometer. The WCA is measured as 0°.

After irradiating the membrane with 1.2V, 808-nm near-infrared light for 1 minute, WCA of the photothermal-responsive nanoemulsion separation membrane is measured in air using a contact angle goniometer. The WCA is measured as 0°.

Oil-water mixtures may be separated using a photothermal-responsive nanoemulsion separation membrane.

For water-in-oil nanoemulsions, the separation performance data are shown in Table 1 as Comparative Example 4.

For oil-in-water nanoemulsions, the hydrophobic/oleophilic membrane is placed in water, CO₂ is bubbled for 5 minutes, and then separation is performed. The performance data are shown in Table 1 as Comparative Example 4.

For re-separating water-in-oil nanoemulsions, a photothermal-responsive nanoemulsion separation membrane is irradiated with 1.2V, 808-nm near-infrared light for 1 minute, then separation is performed.

Cyclic stability of Comparative Example 4. After 2 separation cycles, efficiency drops below 90% for both isooctane-based oil-in-water nanoemulsions (20 nm) and water-in-oil nanoemulsions (20 nm).

Comparison with Comparative Example 4 demonstrates that membranes with only photothermal coating exhibit no wettability switching capability, maintaining a constant water contact angle (WCA) of 0°. This occurs because wettability switching relies exclusively on protonation-deprotonation state transitions within the CO₂-responsive functional layer. Concurrently, separation performance degrades rapidly due to the hydrophilic nature of the photothermal coating. Without the protective outer CO₂-responsive layer, direct water exposure causes rapid dissolution and detachment of the coating layer, thereby enlarging membrane pores and severely compromising separation efficiency.

FIG. 1 (GOM schematic) depicts the membrane structure in this comparative example with a PET fiber core and an outer graphene oxide coating, while FIG. 3B displays an SEM image of the prepared membrane exhibiting a rougher surface texture and lighter color when compared to FIG. 3C's membrane containing a CO₂-responsive coating.

TABLE 1

| | Flux for | Separation | Flux for | Separation |
|---|---|---|---|---|
| | Water-in-Oil | Efficiency for | Oil-in-Water | Efficiency for |
| | Emulsion | Water-in-Oil | Emulsion | Oil-in-Water |
| Sample | (L · m⁻² · h⁻¹) | Emulsion (%) | (L · m⁻² · h⁻¹) | Emulsion (%) |
| Nanoemulsion | 1234 | 99.4 | 846 | 99.3 |
| Separation Membrane-1 | | | | |
| Nanoemulsion | 937 | 99.5 | 684 | 99.5 |
| Separation Membrane-2 | | | | |
| Nanoemulsion | 878 | 99.3 | 557 | 99.2 |
| Separation Membrane-3 | | | | |
| Nanoemulsion | 958 | 99.4 | 784 | 99.3 |
| Separation Membrane-4 | | | | |
| Comparative Example 1 | 236 | 76.5 | 678 | 99.2 |
| Comparative Example 2 | 563 | 96.9 | 683 | 99.3 |
| Comparative Example 3 | 920 | 85.8 | 634 | 88.6 |
| Comparative Example 4 | 1023 | 76.4 | 873 | 82.5 |

What is claimed is:

1. A CO₂-photothermal dual-responsive nanoemulsion separation membrane, characterized in that:
the CO₂-photothermal dual-responsive nanoemulsion separation membrane is woven from fibers having a three-layer structure, wherein the three-layer structure comprises:
an inner core layer being a fiber;
a middle layer being a photothermal conversion functional coating formed from carbon-based nanomaterials and polyvinyl alcohol (PVA); and
an outer layer being a CO₂-responsive functional coating synthesized by free radical polymerization of a CO₂-responsive monomer and a hard monomer;
the CO₂-responsive monomer comprising N,N-dimethyl-p-aminostyrene (DMSt), dimethylaminoethyl methacrylate (DMAEMA), or diethylaminoethyl methacrylate (DEAEMA);
the hard monomer comprising styrene (ST), hydroxyethyl methacrylate (HEMA), acrylamide (AM), methyl methacrylate (MMA), poly (ethylene glycol) methyl ether methacrylate (PEGMA), or 2-ethoxyethyl methacrylate (EEMA);
wherein the CO₂-photothermal dual-responsive separation membrane has a pore size distribution below 0.1 μm.

2. The CO₂-photothermal dual-responsive nanoemulsion separation membrane according to claim 1, wherein:
the fiber comprises polyethylene terephthalate (PET), polyester fiber, polyacrylonitrile fiber, polyamide (nylon) fiber, spandex fiber, carbon fiber, or glass fiber;
the carbon-based nanomaterial comprises one or more of carbon black, carbon nanotube, graphene, graphene oxide (GO), and reduced graphene oxide (rGO).

3. The CO₂-photothermal dual-responsive nanoemulsion separation membrane according to claim 1, characterized in that:
the carbon-based nanomaterial and polyvinyl alcohol (PVA) are present at a mass ratio of 3:1000 to 10:1000;
the CO₂-responsive monomer and hard monomer are present at a molar ratio of 1:1 to 1:2.

4. The CO₂-photothermal dual-responsive nanoemulsion separation membrane according to claim 1, characterized in that the carbon-based nanomaterial and PVA are at a mass ratio of 3:1000.

5. The CO₂-photothermal dual-responsive nanoemulsion separation membrane according to claim 1, characterized in that the CO₂-responsive monomer and hard monomer are at a molar ratio of 1:1.

6. A method for preparing the CO₂-photothermal dual-responsive nanoemulsion separation membrane according to claim 1, characterized in that the method comprises the following steps:
Step S1: preparation of photothermal conversion coating material, wherein S1 includes adding 7.5-12.5 wt % polyvinyl alcohol (PVA) and deionized water to a flask, then adding 0.2-0.5 mg/mL carbon-based nanomaterial to obtain a mixture, and heating and stirring the mixture at 90-110° C. in an oil bath for 30-90 minutes to obtain a photothermal conversion coating material;
Step S2: preparation of a CO₂-responsive coating material, wherein S2 includes synthesizing a CO₂-responsive polymer by free radical polymerization of a CO₂-responsive monomer and one hard monomer in tetrahydrofuran (THF) to obtain a CO₂-responsive polymer and dissolving the obtained CO₂-responsive polymer in ethanol to prepare a CO₂-responsive coating material with a mass fraction of 5-20 wt %;
Step S3: preparation of CO₂-photothermal dual-responsive fibers, wherein S3 includes uniformly coating the photothermal conversion coating material obtained in Step S1 onto surfaces of polyethylene terephthalate (PET) fibers using a sizing machine to obtain coated PET fibers, thermally treating the coated PET fibers at 70-90° C. in an oven for 2-10 minutes to obtain photothermal conversion functional fibers, then uniformly coating the CO₂-responsive coating material obtained in Step S2 onto surfaces of the photothermal conversion functional fibers using the sizing machine, and thermally treating at 70-90° C. for 2-10 minutes to obtain CO₂-photothermal dual-responsive fibers; and
Step S4: preparation of CO₂-photothermal dual-responsive nanoemulsion separation membrane, wherein S4 includes weaving the CO₂-photothermal dual-responsive fibers obtained in Step S3 to form a membrane using a loom, thereby obtaining the CO₂-photothermal dual-responsive nanoemulsion separation membrane.

7. The method for preparing the CO₂-photothermal dual-responsive nanoemulsion separation membrane according to claim 6, characterized in that, in step S2, the CO₂-responsive coating material is a transparent material, and when the CO₂-responsive coating material is formed into a film, the film has a light transmittance of 85-92%.

8. A use of the CO₂-photothermal dual-responsive nanoemulsion separation membrane according to claim 1, characterized in that the CO₂-photothermal dual-responsive nanoemulsion separation membrane achieves reversible switching between a superhydrophobic state and a superhydrophilic state under CO₂ stimulation or photothermal stimulation.

9. The use according to claim 8, characterized in that:
the CO₂ stimulation comprises placing the nanoemulsion separation membrane in an aqueous environment and bubbling CO₂ for 5-10 minutes;
the photothermal stimulation comprises irradiating the nanoemulsion separation membrane with a near-infrared light, wherein the membrane elevates its temperature to 120-180° C. within 10-20 seconds.

10. The use of the CO₂-photothermal dual-responsive nanoemulsion separation membrane according to claim 8, when the CO₂-photothermal dual-responsive nanoemulsion separation membrane separates an oil-water mixture:
if the mixture type is a water-in-oil nanoemulsion, using the membrane in an initial hydrophobic/oleophilic state to perform separation;
if the mixture type is an oil-in-water nanoemulsion, placing the hydrophobic/oleophilic separation membrane in an aqueous environment, bubbling CO₂ for 5-10 minutes to convert it to a hydrophilic/underwater oleophobic separation membrane, then performing separation;
when needing to separate a water-in-oil nanoemulsion again, placing the hydrophilic/underwater oleophobic separation membrane in an aqueous environment, irradiating with a 1.2-2 V, 780-900 nm near-infrared light for 1-2 minutes to reconvert the hydrophilic/underwater oleophobic separation membrane to a reconverted hydrophobic/oleophilic separation membrane, then performing separation.
